(19) United States
(12) Patent Application Publication
(10) Pub. No.: US 2005/0116391 A1
(43) Pub. Date: Jun. 2, 2005

(54) Apparatus and process for producing a three-dimensional shaped body

(76) Inventors: Markus Lindemann, Gerlingen (DE); Bernd Hermann Renz, Marbach (DE); Joachim Hutfless, Ditzingen-Schockingen (DE); Gerhard Hammann, Korntal-Munchingen (DE)

Correspondence Address: M. Robert Kestenbaum, 11011 Bermuda Dunes NE, Albuquerque, NM, 87111, US

(21) Appl. No.: 10/940,238

(22) Filed: Sep. 14, 2004

(30) Foreign Application Priority Data
Sep. 15, 2003 (DE) 103 42 882.8

(51) Int. Cl. B29C 35/08

(52) U.S. Cl. 264/497; 264/113; 425/174.4

(57) ABSTRACT

The invention relates to an apparatus and a process for producing a three-dimensional shaped body by successive consolidation of layers of a pulverulent build-up material, which can be consolidated by means of electromagnetic radiation or particle radiation, at locations corresponding to the respective cross section of the shaped body, having a beam source for generating a focussed beam and a deflection device for diverting the focussed beam onto the layer which is to be consolidated, having a carrier in a build-up chamber, adjacent to a process chamber, for receiving the shaped body which is to be formed, wherein at least two working stations are formed by in each case one process chamber, the process chambers are hermetically locked off and are each designed to be separate from one another, and the deflection device and the at least two working stations can be positioned in a working position with respect to one another.

### CROSS REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### FIELD OF THE INVENTION

The invention relates to an apparatus and a process for producing a three-dimensional shaped body which is consolidated by means of electromagnetic radiation or particle radiation, at locations corresponding to the respective cross section of the shaped body, having a beam source for generating a beam and a beam-deflection device for deflecting the beam onto the layer which is to be consolidated, having a carrier in a build-up chamber, arranged in a process chamber, for receiving the shaped body which is to be formed.

### TECHNICAL FIELD

The present invention deals with additive manufacturing processes in which complex, three-dimensional components are built up in layers from material powders. The application areas for the invention include, in addition to rapid prototyping and the related disciplines of rapid tooling and rapid manufacturing, in particular the production of series tools and functional parts. These include, for example, injection moulds with cooling passages close to the surface and also individual parts and small series of complex functional components for medical technology, mechanical engineering, aircraft and automotive construction.

The generative manufacturing processes which are of relevance to the present invention include laser melting, which is known, for example, from DE 196 49 865 C1, in the name of Fraunhofer-Gesellschaft, and laser sintering, which is known, for example, from U.S. Pat. No. 4,863,538, in the name of the University of Texas.

In the laser-melting process which is known from DE 196 49 865 C1, the components are produced from commercially available, single-component metallic material powders without binders or other additional components. For this purpose, the material powder is in each case applied as a thin layer to a building platform. This powder layer is locally fused using a laser beam in accordance with the desired component geometry. The energy of the laser beam is selected in such a way that the metallic material powder is completely fused over its entire layer thickness at the location of incidence of the laser beam. At the same time, a shielding gas atmosphere is maintained above the zone where the laser beam interacts with the metallic material powder, in order to avoid defects in the component which may be caused, for example, by oxidation. It is known to use an apparatus shown in FIG. 1 of DE 196 49 865 C1 to carry out the process.

In the laser-sintering process which is known from U.S. Pat. No. 4,863,538, the components are produced from material powders which have been specially developed for laser sintering and which, in addition to the base material, contain one or more additional components. The different powder components differ in particular in terms of the melting point. In the case of laser sintering, the material powder is applied to a building platform as a thin layer. This powder layer is locally irradiated with a laser beam in accordance with the geometry data of the component. The low-melting components of the material powder are fused by the laser energy which is introduced, while others remain in the solid state. The layer is secured to the previous layer by means of the fused powder components, which produce a bond on solidification. After a layer has been built up, the building platform is lowered by the thickness of one layer, and a new powder layer is applied from a storage vessel.

EOS GmbH Electro Optical Systems offers laser-sintering installations for processing plastics EOSINT P 700 and for processing sand EOSINT S 750, which installations have a process chamber, two lasers and two scanning units. The aim of these installations is to rapidly build up components of large volume.

According to WO 02/36331, Concept Laser GmbH proposes, for the production of components of relatively large volume, an apparatus for sintering, removal of material and/or writing by means of electromagnetic, focussed radiation, in which a scanner is arranged on a scanner carrier which can be displaced by motor means, in the style of a compound slide, over the building platform.

This apparatus includes a laser-processing machine with exchangeable technology modules for sintering, removal of material and/or writing. A plurality of building spaces are provided in a machine housing. The scanner carrier executes a reciprocating movement between the building spaces, so that a plurality of building spaces can be covered in any desired order. By way of example, it is proposed to provide four building spaces in an arrangement which approximates to a square, in order for four components to be built up, or processed in some other way, simultaneously and in parallel in a single machine. For this purpose, it is necessary for the scanner carrier to move to and fro between the building spaces in order to allow this simultaneous production of a plurality of components in the building spaces of a machine.

This arrangement has the drawback that the accessibility to the individual building spaces in a machine housing is made more difficult by the scanner carrier which can be displaced by motor means in the style of a compound slide and extends transversely across the building spaces. Furthermore, the parallel mode of action in the individual building spaces means that it is only possible to remove a finished component and carry out the necessary conversion work for a new component when the shaped bodies which are to be built up in parallel with the finished component in the further building spaces have also been completed. This has an adverse effect on the economics of this apparatus, since the component with the longest build-up time determines the removal and conversion work. Furthermore, the influences which arise during the production process, such as for example temperature, sparks which fly when a shaped body is being built up, may have an adverse effect on the further working processes proceeding in parallel therewith, such as for example coating, cooling, etc.

### SUMMARY OF THE INVENTION

Therefore, the invention is based on the object of providing an apparatus and a process for producing a three-dimensional shaped body in which the production time is shortened and the flexibility of production and the quality of the shaped bodies are increased.

This object is achieved by an apparatus in that at least two process chambers are provided, in that each process chamber is hermetically locked off and is in each case designed to be separate from the adjacent process chamber, and in that the beam-deflection device and the at least two process chambers are positioned in a processing position with respect to one another. This invention is carried out by a process for producing a three-dimensional shaped body, wherein in a first process chamber a layered build-up is carried out by successive consolidations of layers of a pulverulent build-up material, which is consolidated by means of electromagnetic radiation or particle radiation, to produce a shaped body, and at least a cooling, an extraction of build-up material that has not been consolidated, a removal of the finished component, a conversion or setting-up for the production of a new shaped body is carried out in at least a second process chamber.

The apparatus according to the invention significantly improves the economics of the production of shaped bodies. A shaped body is completely produced in a first process chamber, while cooling and unloading of the previously produced shaped body take place in at least one further process chamber, or the process chamber is converted or set up for a shaped body which is to be produced subsequently. This results in a high utilization of the capacity of the beam source, since it is transferred to the next process chamber immediately after a shaped body has been produced, in order to produce the next shaped body in the at least one further process chamber.

Furthermore, the formation of at least two hermetically locked process chambers allows a shaped body to be built up using a defined material in a first process chamber, whereas a shaped body can be built up using the same material powder or a material powder which is different from the first shaped body can be built up in at least one further process chamber. This arrangement is of particular importance for use in medical technology, since a high degree of purity of the material powders used is required.

Furthermore, the apparatus according to the invention has the advantage that it is possible to realise layers without the need for an operator, since a number of shaped bodies which corresponds to the number of process chambers can be produced in direct succession without any intervention from an operator.

The positioning of the at least one beam-deflection device directly to a process chamber, furthermore, provides good accessibility to the second or further process chambers in order for the shaped bodies produced to be removed and to allow the process chamber to be converted or set up for a subsequent working process as required.

The hermetically locked configuration of the process chamber also has the advantage that it is possible to produce a shaped body without any influence from immediately adjacent conversion work, cooling processes, impurities from the environment or the like.

According to an advantageous configuration of the invention, it is provided that each process chamber has an extraction means for build-up material that has not been consolidated, which extraction means comprises at least one barrier device. This barrier device prevents build-up material from being extracted from a process chamber which is currently carrying out the layered build-up of a shaped body when extraction of the build-up material that has not been consolidated is being carried out in a further process chamber. The working processes in one process chamber can proceed without interference from and independently of the working processes in the adjacent process chambers.

Furthermore, arranging the barrier devices in a closed position with respect to the process chamber has the advantage that a shielding gas atmosphere is maintained during the working process for consolidation of the individual powder layers. This increases the process reliability and, at the same time, ensures that there is only a low consumption of shielding gas.

According to a further advantageous configuration of the invention, it is provided that a fan is provided for the at least two process chambers, and at least one barrier device is provided in the extraction means between the fan and each process chamber. To reduce the overall space required and also the costs, by way of example a fan is provided, which is designed for operation for at least two process chambers. This also makes it possible to simplify the structure. To hermetically lock the process chambers and to operate them independently of one another, at least one barrier device is arranged in the extraction means between the fan and each process chamber, so that when the fan is operated extraction by suction is carried out at that process chamber in which the shaped body has been fully produced, while there is no extraction by suction for the other, further process chambers. This makes it possible to eliminate the possibility of the process chambers influencing one another when common component parts are used.

The process chambers have inlet openings, which can advantageously each be closed by a barrier device. The barrier devices are therefore assigned directly to the process chamber, so that further disruptive influencing factors are eliminated. The barrier devices of the inlet openings may be actuable together with the barrier devices of the outlet openings.

According to a preferred embodiment, the barrier devices are provided at least in an outlet opening which is in communication with a build-up chamber and with a powder trap. This provides for the hermetic locking of the process chamber. In addition, it is possible to provide for a feed opening, which supplies a volumetric flow during extraction of the process chamber, likewise to be closable by a barrier device. It is preferable for a barrier device to be provided in an outlet opening of a manual extraction device. This manual extraction device is used for manual extraction of powder residues. Consequently, the hermetic locking and the use of the fan can be optimized.

Each barrier device can preferably be actuated separately or jointly as a group for each process chamber by means of a control and arithmetic unit. This allows autonomous operation of the process chambers and process monitoring.

According to an advantageous embodiment of the invention, the barrier devices are designed as pinch valves and can preferably be actuated pneumatically. These pinch valves have the advantage of being virtually free from wear and having short reaction times. As an alternative to pneumatic actuation, it is also possible to provide hydraulic, electrical or electromagnetic actuation.

Furthermore, to make each process chamber autonomous, it is advantageously provided that the extraction of build-up material that has not been consolidated comprises a separation device and a filter. This allows the build-up material which has not been fused and consolidated to be recycled without impurities, for example from a further material from an adjacent process chamber, so that it is possible to reduce the amount of material used and, at the same time, ensure the purity of the processed materials on account of a closed circuit. It is advantageously provided for the powder which has been removed from the process chamber to be processed further by screening or the like. This further processing or preparation may be provided by a device provided in the apparatus or externally, and in the case of the latter, external option, it is preferable to form an interface with the separation apparatus, for which purpose a collection vessel is provided exchangeably for the external purification and preparation or further processing of the powder.

According to a further advantageous configuration of the invention, it is provided that there is a suction fan for at least two process chambers, which is in each case connected downstream of a separation apparatus belonging to the process chamber, for the extraction of build-up material that has not been consolidated and for the cooling of the process chamber and preferably the building platform. This allows isolated separation of the build-up material that has not been consolidated while using a common fan, in order to maintain the separation between the build-up materials used in the respective process chamber. It is preferable for the barrier device to be arranged upstream of the filter and the separation device, close to the process chamber. Each hermetically sealed process chamber is accessible through a closable opening facing towards the beam-deflection apparatus. This makes it possible to provide good accessibility to the process chamber, provided that the beam-deflection device is positioned at the further process chamber.

It is advantageously provided that the closable opening comprises a region which substantially transmits the electromagnetic radiation and is at least larger than a building platform provided on a lifting table for receiving at least one shaped body. This creates sufficient space for the electromagnetic radiation to be introduced. At the same time, the operating staff can carry out a visual check and monitoring of the process chamber. The transparent region provided in the closable opening is preferably formed from a glass, which preferably comprises two surfaces provided with an antireflection coating. This allows optimum beam introduction and optimum impingement of the radiation on the layer which is to be built up.

To hermetically lock the process chamber, it is advantageously provided that a feed device for supplying the build-up material is provided in a position which closes off the process chamber at least after the build-up material has been fed into the process chamber. This configuration makes it possible to prevent oxidation from the penetration of air during fusion of the build-up material and to prevent undefined cross sections from being built up by the introduction of further build-up material. At the same time, it is possible to prevent powder which is intended for build-up purposes being sucked into the process chamber during the process of extracting build-up material that has not been consolidated following production of the shaped body.

A seal is provided for the purpose of sealing between the process chamber and a cover which can be closed by the opening. As a result, a seal for hermetic locking is formed in a simple way. Shielding or inert gas is fed to and discharged from the process chamber while the layers are being built up. A closed circuit resulting from the closed process chamber and line routing reduces the operating costs.

Furthermore, to hermetically lock the process chamber, it is advantageously provided that at least one seal or a sealing configuration of the parts is provided between the carrier for receiving a shaped body and a build-up chamber surrounding the carrier. During fusion, the process chamber is filled with shielding or inert gas and is operated at a superatmospheric pressure, in order to prevent oxygen from entering the process chamber.

To hermetically lock the process chamber, it is advantageously provided that an encircling groove with a sealing ring is arranged on a lifting table which is part of a carrier. The diameter of this sealing ring is preferably designed to be slightly variable, so that a configuration with sealing contact is produced as a result of the different levels of heating during production of the shaped body.

It is preferable for the sealing ring to be formed from a material which is worn to a greater extent than the peripheral wall of the build-up chamber. As a result, simple replacement of the sealing ring after multiple use is sufficient to achieve a sealed arrangement in the build-up chamber.

The peripheral wall of the build-up chamber preferably has a surface hardness which is higher than that of the build-up material. As a result, it is possible to form a low-maintenance build-up chamber. It is advantageous for the build-up chamber to be surface-coated, preferably chromium-plated.

Furthermore, it is advantageous for a sealing ring or stripper to be provided adjacent to or assigned to an end face of the building platform, in order to form a first seal. This stripper, which is advantageously designed as a felt ring, has the advantage that it is possible to compensate for a relatively extensive temperature variation between the peripheral wall of the build-up chamber and the building platform. To increase the quality of the shaped body, the building platform is heated, so that temperature differences which lead to differing expansion of the building platform and the build-up chamber are produced between the building platform and the peripheral wall of the build-up chamber and are compensated for by the stripper.

Furthermore, for hermetic locking of the process chamber, it is advantageously possible to provide a shaft seal which is provided on a lifting rod of the lifting table. According to a further advantageous configuration of the invention, a beam-deflection device which can be positioned with respect to the individual process chambers is provided. This makes it possible to reduce the production costs for the apparatus according to the invention by virtue of the fact that a common beam source and a common beam-deflection device are used irrespective of the number of process chambers.

For simple, correct positioning of the beam-deflection device, it is advantageous to provide a linear guide, along which the beam-deflection device can be displaced and can preferably be positioned accurately with respect to the process chamber. The linear guide is advantageously arranged at a low height above the respective process chamber, so that there is a short distance between the deflection device and the layer which is to be built up in order to produce a shaped body in order in particular to achieve a narrow width of the fused track.

According to an alternative configuration of the invention, there is provision for the at least two process chambers to be displaceable with respect to the beam-deflection device. By way of example, it is possible to provide a type of turret arrangement or to provide a plurality of process chambers in a row, which process chambers can be displaced with respect to a stationary beam-deflection device. In particular in the case of a turret-like arrangement, it is possible to achieve very high utilization of the beam source and unsupervised production of shaped bodies over a prolonged period of time.

According to a preferred embodiment of the invention, it is provided that at least two hermetically locked, separate process chambers and a beam source and a beam-deflection device, which can be positioned at at least two process chambers, are provided in a machine housing in order to form a multichamber system. This apparatus has the advantage that those components which ensure autonomous operation of each process chamber are provided multiply, and those components which are required for the overall installation to function are provided just once. This makes it possible to create an apparatus which allows high utilization of the beam source and at the same time is optimized in terms of production costs.

In particular, the apparatus according to the invention makes it possible to carry out a process for producing a three-dimensional shaped body in which complete production of a shaped body is carried out in a first process chamber, with cooling and unloading of a finished shaped body, conversion or setting up of the process chamber for the production of a further shaped body being possible in parallel in at least a second process chamber. This creates the conditions for economic production of shaped bodies. Furthermore, it is possible to process different materials. The hermetically locked process chambers enable different process parameters to be run in order to satisfy particular demands on the build-up, the surface quality and on a low-stress, crack-free build-up of the shaped bodies.

According to a preferred embodiment, each process chamber has at least one inlet opening leading into the process chamber and at least one outlet opening leading away from it for shielding or inert gas. As a result, a suitable shielding gas or inert gas can be supplied as a function of the material used to build up the shaped body. Consequently, the respective process chambers are configured completely independently of one another and can be set to specific requirements for production of a shaped body.

According to an advantageous embodiment of the process, it is provided that barrier devices for the at least one further process chamber are held in a closed position during the extraction of build-up material that has not been consolidated or the cooling of a shaped body that has been produced in a process chamber. As a result, the process chambers are hermetically locked with respect to one another, and the working steps which take place and are ongoing in the respective process chambers do not influence one another. This increases utilization of the apparatus and improves the quality of the shaped body.

### BRIEF DESCRIPTION OF THE DRAWINGS

The invention and further advantageous embodiments and refinements thereof are described and explained in more detail below on the basis of the examples illustrated in the drawings. According to the invention, the features revealed in the description and the drawings can be employed individually on their own or in any desired combination. In the drawings:

FIG. 1 shows a diagrammatic side view of an apparatus according to the invention,

FIG. 2 shows a diagrammatic sectional illustration of a process chamber in a working position during production of a shaped body,

FIG. 3 shows a diagrammatic sectional illustration of the process chamber shown in FIG. 2 after layered build-up of a shaped body, in a cooling position,

FIG. 4 shows a diagrammatic sectional illustration of the process chamber shown in FIG. 2 after layered build-up of a shaped body in an extraction position,

FIG. 5 shows a diagrammatic part-section through a process chamber with a feed device, and

FIG. 6 shows a diagrammatic illustration of two process chambers and a connection between the associated components.

### DETAILED DESCRIPTION OF THE DRAWINGS

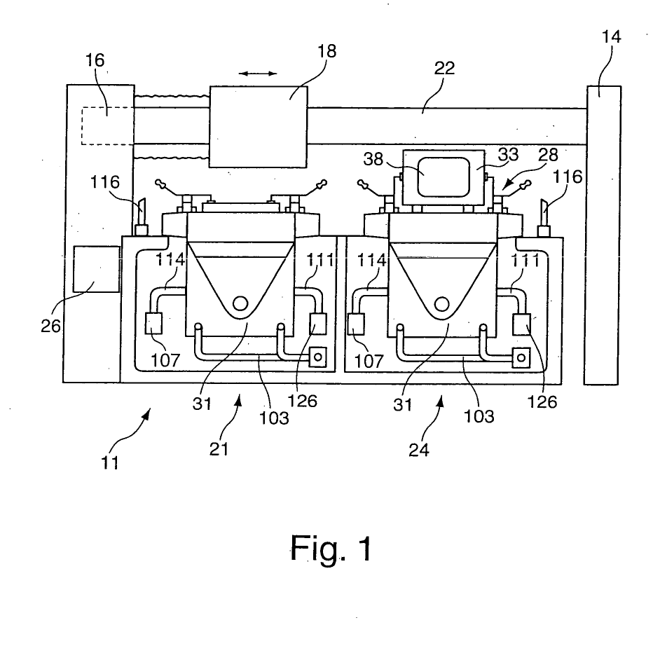

FIG. 1 diagrammatically depicts an apparatus 11 according to the invention for the production of a three-dimensional shaped body by successive consolidation of layers of a pulverulent build-up material. The production of a shaped body by laser fusion is described, for example, in DE 196 49 865 C1. The apparatus 11 comprises a beam source 16, which is arranged in a machine frame 14, in the form of a laser, for example a solid-state laser, which emits a directed beam. This beam is focused via a beam-deflection device 18, for example in the form of one or more actuable mirrors, as a deflection beam onto a working plane in a process chamber 21. The beam-deflection device 18 is arranged such that it can be displaced by motor means along a linear guide 22 between a first process chamber 21 and a further process chamber 24. The beam-deflection device 18 can be moved into a precise position with respect to the process chambers 21, 24 by means of actuating drives. Furthermore, the machine frame 14 provides a control and arithmetic unit 26 for operation of the apparatus 11 and for setting individual parameters for the working processes used to produce the shaped bodies.

The first process chamber 21 and at least one further process chamber 24 are arranged separately from one another and are hermetically isolated from one another.

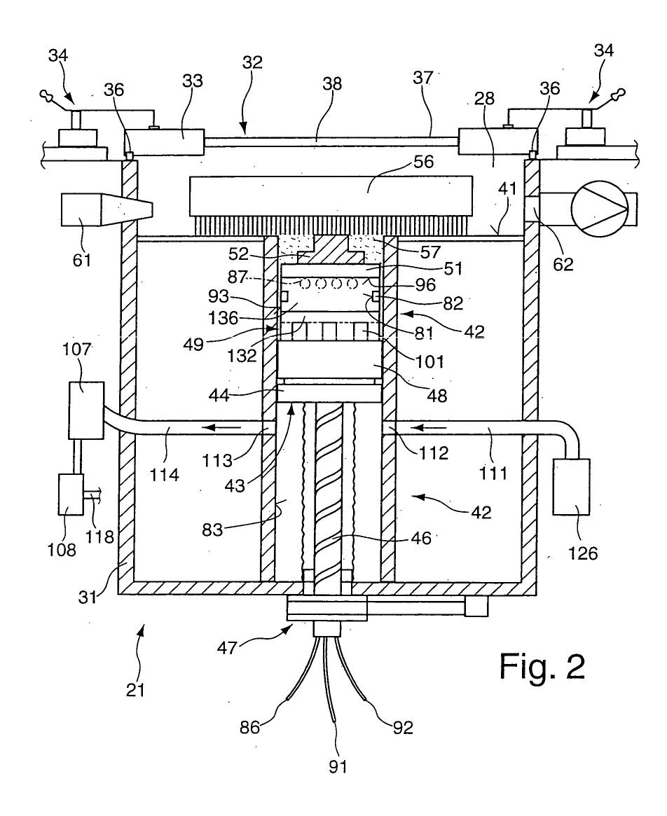

FIG. 2 illustrates the process chamber 21, by way of example, fully in cross section. The process chamber 21 comprises a housing 31 and is accessible through an opening 32 which can be closed off by at least one closure element 33. The closure element 33 is preferably designed as a pivotable cover which can be fixed in a closed position by locking elements 34, such as for example toggle lever elements. A seal 36, which is preferably formed as an elastomer seal, is provided at the housing 31, close to the opening 32, to seal off the process chamber 21. The closure element 33 has a region 37 which transmits the electromagnetic radiation of the laser beam. It is preferable to use a window 38 made from glass or quartz glass which has antireflection coatings on the top side and the underside. The closure element 33 may preferably be of water-cooled design.

The process chamber 21 comprises a base surface 41. A build-up chamber 42, in which a carrier 43 is provided and guided such that it can move up and down, opens out into this base surface 41 from below. The carrier 43 comprises at least one base plate 44, which is driven such that it can be moved up and down by means of a lifting rod or lifting spindle 46. For this purpose, a drive 47, for example a toothed belt drive, is provided to move the fixed lifting spindle 46 up and down. The base plate 44 of the carrier 43 is cooled by a fluid medium, which preferably flows through cooling passages in the base plate 44, at least during the layered build-up. An insulation layer 48 made from a mechanically stable, thermally insulating material is arranged between the base plate 44 and the building platform 49 of the carrier 43. This prevents the lifting spindle 46 from being heated by the heating of the building platform 49, with an associated effect on the positioning of the carrier 43.

An application and levelling device 56, which applies a build-up material 57 into the build-up chamber 42, moves along the base surface 41 of the process chamber 21. A layer is built up on the shaped body 52 by selective fusion of the build-up material 57.

The build-up material 57 preferably comprises metal or ceramic powder. Other materials which are suitable and used for laser fusion and laser sintering are also employed. The individual material powders are selected as a function of the shaped body 52 to be produced.

On one side, the process chamber 21 has an inlet nozzle 61 for the supply of shielding gas or inert gas. At an opposite side, there is an extraction nozzle or extraction opening 62 for removing the supplied shielding or inert gas. During production of the shaped body 52, a laminar flow of shielding or inert gas is generated, in order to avoid oxidation during fusion of the build-up material 57 and to protect the window 38 in the closure element 33. It is preferable for the hermetically locked process chamber 21 to be held at a superatmospheric pressure of, for example, 20 hPa during the build-up process, although significantly higher pressures are also conceivable. This means that it is impossible for any atmospheric oxygen to penetrate into the process chamber 21 from the outside during the build-up process. During circulation of the shielding or inert gas, it is simultaneously also possible to realise cooling. It is preferable for cooling and filtering of the shielding or inert gas to remove entrained particles of the build-up material 57 to be provided outside the process chamber 21.

The build-up chamber 42 is preferably of cylindrical design. Further geometries may also be provided. The carrier 43 or at least parts of the carrier 43 are matched to the geometry of the build-up chamber 42. In the build-up chamber 42, the carrier 43 is moved downwards with respect to the base surface 41 in order to effect a layered build-up. The height of the build-up chamber 42 is matched to the build-up height or the maximum height to be built up for a shaped body 52.

A peripheral wall 83 of the build-up chamber 42 directly adjoins the base surface 41 and extends downwards, this peripheral wall 83 being suspended from the base surface 41. At least one inlet opening 112 is provided in the peripheral wall 83. This inlet opening 112 is in communication with a feed line 111 which accommodates a filter 126 outside the housing 31. Ambient air is fed to the build-up chamber 42 through the inlet opening 112 via the filter 126 and the supply line 111. Furthermore, the build-up chamber 42 has at least one outlet opening 113 in the peripheral wall 83, to which outlet opening there is connected a discharge line 114 which leads out of the housing 31 and opens out into a separation device 107. Downstream of the latter there is a filter 108 which discharges the volumetric flow that has been discharged from the build-up chamber 42 via a connecting line 118. It is advantageously provided that the inlet opening 112 and the outlet opening 113 are aligned with one another. It is also possible for the openings 112, 113 to be arranged offset with respect to one another, both in terms of the height and in terms of their feed position in the radial direction or at right angles to the longitudinal axis of the build-up chamber 42.

The building platform 49 is composed of a heating plate 136 and a cooling plate 132. Heating elements 87 are illustrated by dashed lines in the heating plate 136. Furthermore, the heating plate 136 comprises a temperature sensor (not shown in more detail). The heating elements 87 and the temperature sensor are connected to supply lines 91, 92, which in turn are routed through the lifting spindle 46 to the building platform 49. A peripheral groove 81, in which one or more sealing rings 82 are fitted, is provided at the external periphery 93 of the building platform 49; the diameter of the sealing ring(s) 82 can be altered slightly and matched to the installation situation and temperature fluctuations. The sealing ring(s) 82 bear(s) against a peripheral wall 83 of the build-up chamber 42. This sealing ring 82 has a surface hardness which is lower than that of the peripheral wall 83. The peripheral wall 83 advantageously has a surface hardness which is greater than the hardness of the build-up material 57 provided for the shaped body 52. This makes it possible to ensure that there is no damage to the peripheral wall 83 during prolonged use, and only the sealing ring 82, as a wearing part, has to be replaced at maintenance intervals. It is advantageous for the peripheral wall 83 of the build-up chamber 42 to be surface-coated, for example chromium-plated.

The base plate 44 comprises a water cooling system which is in operation at least while the shaped body 52 is being built up. Cooling liquid is fed to the cooling passages provided in the base plate 44 via a cooling line 86 which is fed to the base plate 44 through the lifting spindle 46. The cooling medium provided is preferably water. The cooling allows the base plate 44 to be set, for example, to a substantially constant temperature of 20° C. to 40° C.

To receive a shaped body 52, the carrier 43 has a substrate plate 51 which is positioned fixedly or releasably on the carrier 43 by means of a retaining means and/or an orientation aid. Before production of a shaped body 52 commences, the heating plate 136 is heated to an operating temperature of between 300° C. and 500° C., in order to allow the shaped body 52 to be built up with low stresses and without cracks. The temperature sensor (not shown in more detail) records the heating temperature or operating temperature while the shaped body 52 is being built up.

The building platform 49 has cooling passages 101, which preferably extend transversely throughout the entire building platform 49. It is possible to provide one or more cooling passages 101. The position of the cooling passages 101 is, for example, illustrated adjacent to the insulating layer 48 in accordance with the exemplary embodiment. Alternatively, it is possible for the cooling passages 101 to extend not just beneath heating elements 87 but also above and/or between the heating elements 87.

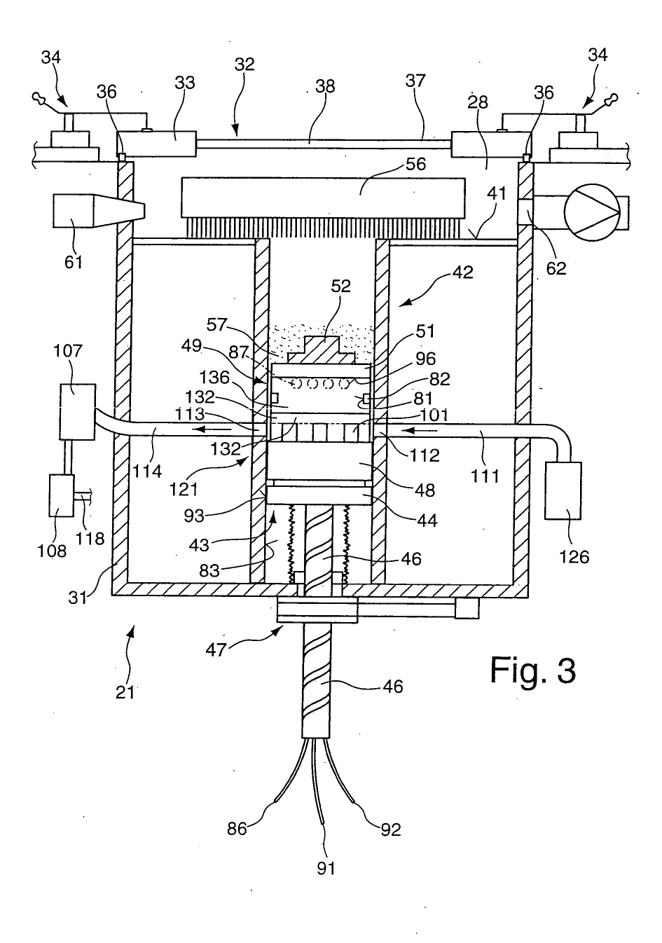

After completion of the shaped body 52, the carrier 43 is lowered from the position illustrated in FIG. 2 into a first position or cooling position 121. This position is illustrated in FIG. 3. Even while the carrier 43 is being lowered, a volumetric flow from the environment can be fed via the filter 126 and the supply line 111 to the build-up chamber 42 and discharged from the build-up chamber 42 via the outlet opening 113 and discharge line 114. The build-up chamber 42 can be cooled as early as at this stage and also while the shaped body 52 is being built up.

The cooling position 121 of the carrier 43 is provided in such a manner that cooling passages 101 of the building platform 42 are aligned with the at least one inlet opening 112 and at least one outlet opening 113 in the peripheral wall 83 of the build-up chamber 42. The volumetric flow flows through the cooling passages 101, thereby cooling at least the building platform 49. The cooling may be effected by a pulsed suction stream. The cooling rate in the shaped body 52 can be determined by the pulse/pause ratio. It is preferable to provide for uniform cooling for a predetermined period of time, to minimize the build-up of internal stresses in the shaped body 52. The cooling may also be provided by a volumetric flow which continuously increases or decreases in quantitative terms. It is also possible to alternate between an increase and a decrease in order to obtain the desired cooling rate. The cooling rate can be recorded by the temperature sensor provided in the heating plate 136. At the same time, the residual temperature of the shaped body 52 can be derived via this temperature sensor. This cooling position 121 is maintained until the shaped body 52 has been cooled to a temperature of, for example, less than 50° C. At the same time, the base plate 44 can be cooled further in this cooling position 121. In addition it is also possible to provide for cooling passages or cooling hoses to be provided adjacent to the peripheral wall 83 of the build-up chamber 42 or in the peripheral wall 83 of the build-up chamber 42, these cooling passages or cooling hoses also contributing to cooling of the build-up chamber 42, the shaped body 52 and the carrier 43.

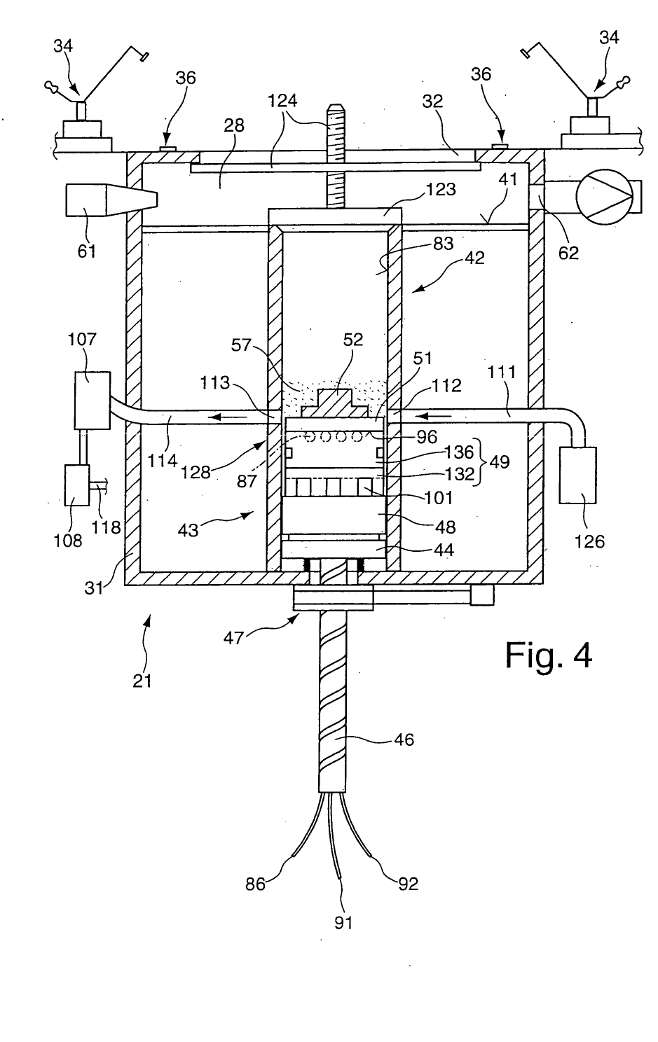

After the shaped body 52 has been cooled to the desired or preset temperature, the carrier 43 is transferred into a further position or suction position 128, which is illustrated in FIG. 4. This suction position 128, which is illustrated by way of example, is used to remove, in particular suck out, the build-up material 57 which has not been consolidated during production of the shaped body 52. The build-up chamber 42 is closed by a closure element 123 prior to the application of a suction stream flowing through the build-up chamber 42. This closure element 123 has securing elements 124 which act on or in the opening 32 in order to fix the closure element 123 tightly to the build-up chamber 42. The closure element 123 is preferably of transparent design, so that it is possible to monitor the sucking-out of build-up material 57 that has not been consolidated. A suction stream flowing through the build-up chamber 42 generates a swirl in the build-up chamber 42, with the result that the build-up material 57 that has not been consolidated is sucked out and fed to the separation device 107 and the filter 108. At the same time, furthermore, the suction is responsible for cooling the build-up chamber 42, the shaped body 52 and the building platform 49. In addition, it is possible to effect a further supply of air via at least one nozzle in the closure element 123.

The sucking-out of the build-up material 57 can be operated by a constant volumetric flow, a pulsed volumetric flow or a volumetric flow with an increasing or decreasing mass throughput. The suction is terminated after a predetermined duration of the suction or after a period of time which can be set by the operating staff.

To remove the shaped body 52, the closure element 123 is removed from the build-up chamber 42 and the carrier 43 moves into an upper position, so that the shaped body 52 is positioned at least partially above the base surface 41 of the process chamber 21 in order to be removed.

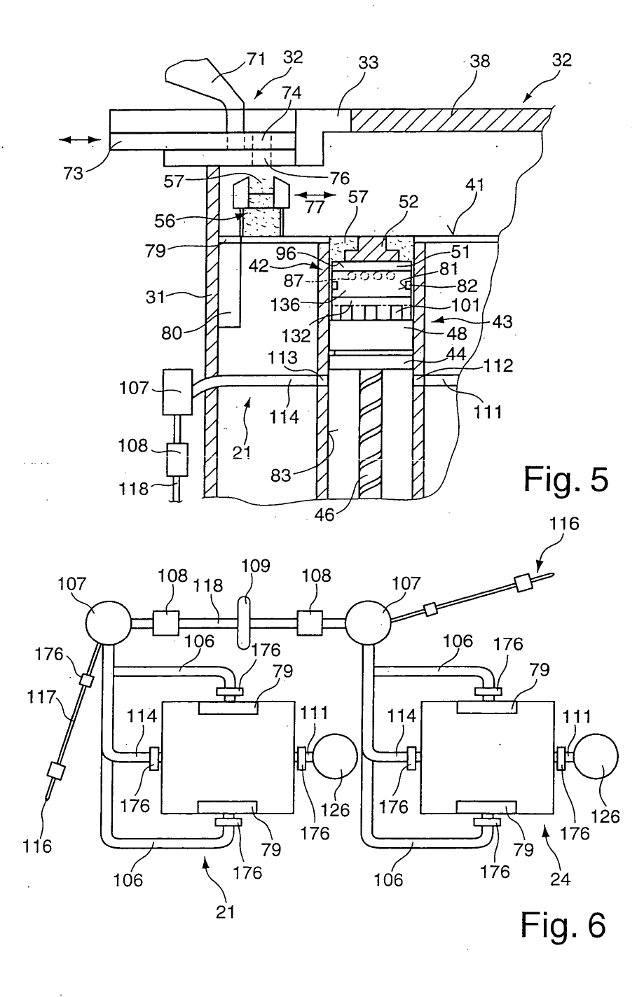

FIG. 5 illustrates an exemplary embodiment for feeding the build-up material 57 via a feed device 72 into the process chamber 21. The partial section shows a feed passage 71 which is in communication with a collection vessel or storage vessel (not shown in more detail) and provides build-up material 57. The feed device 72 comprises a slide 73, which preferably has a slot-like opening 74 which, in a first position, enables the build-up material 57 to pass into the opening 74. After the slide 73 has been positioned in a second position, the build-up material 57 stored in the opening 74 is conveyed via a gap 76 into the application and levelling device 56, which then transfers the build-up material 57 into the build-up chamber 42 as a result of a reciprocating movement indicated by arrow 77. Cutouts 79, through which excess build-up material 57 can be discharged into a receptacle or powder trap 80, are provided in the base surface 41 at the reversal points for the reciprocating movement of the application and levelling device 56. Therefore, after the build-up material 57 has been introduced into the build-up chamber 42, the base surface 41 is substantially free of build-up material 57. This configuration of the feed device 72 allows a portioned supply of build-up material 57 into the process chamber 28. Furthermore, this feed device 72 allows a rapid and simple change from one build-up material 57 to another build-up material 57, since this feed device 72 allows the build-up material 57 to be introduced into the process chamber 21 virtually without residues. Further solutions relating to the configuration of the feed device 72 are likewise possible. By way of example, the portioned supply of the build-up material 57 may also be effected by means of a controllable closure element and a sensor element by which the feed quantity is determined. It is also possible, as an alternative to the application and levelling device 56 described, to use a device which introduces the build-up material 57 into the build-up chamber 42 in the style of a printing process.

The double-chamber or multi-chamber principle is described below with reference to FIG. 6, which shows a diagrammatic plan view of the apparatus 11 according to the invention, reference also being made at the same time to the previous figures.

Each process chamber 21, 24 comprises a filter 126, through which purified ambient air is fed to a build-up chamber 42 via a feed line 111. A discharge line 114 discharges the volumetric flow from the build-up chamber 42, and this flow, outside the housing 31, is fed to a separation device 107. A filter 108 is connected downstream of the separation device 107. Furthermore, the process chamber 21, 24 in each case comprises a line 106 which discharges the build-up material 57 that has been collected in a powder trap 80 from the housing 31 and feeds it to the separation device 107 or the discharge line 114. This line 106 is in communication with an outlet opening of the powder trap 80 in the housing 31, through which build-up material 57 that is not required is collected.

Each process chamber 21, 24 is assigned barrier devices 176 designed as shut-off valves. In a preferred embodiment, these barrier devices 176 are provided in the outlet opening 113 of the discharge line 114 and in the outlet openings of the powder traps 80 into which the lines for discharging powder open out. Furthermore, these barrier devices 176 may be provided between the process chamber 21, 24 in a line section of the discharge line 114 and the line 106 upstream of a separation device 107. Furthermore, it is advantageously provided that a barrier device 176 is also provided in a suction line 117 of a nozzle 116 for the manual extraction of build-up material 57 that has not been consolidated or assigned to the nozzle 116. In addition, to increase reliability, it is possible to provide further barrier devices 176. By way of example, it is possible to provide a barrier device 176 in the inlet opening 112 of the feed line 111. Furthermore, it is additionally possible to provide a barrier device 176 in the connecting lines 118 which in each case open out from the process chamber 21, 24 into the fan 109 in order to form further safety functions.

The barrier devices 176 can be actuated individually or combined in functional groups, so that the actuation is incorporated in the individual working processes, such as production of the shaped body, cooling of the carrier and extraction of the build-up material 57 that has not been consolidated. This ensures that, for example during the extraction of build-up material 57 that has not been consolidated or during cooling of the carrier 43 in the process chamber 21, the process chamber 24 is hermetically locked off from the process chamber 21 by closing the barrier devices 176 of the process chamber 24. It is preferable for the barrier device 176 used to be pinch valves, which have a long service life.

The barrier devices 176 are preferably actuated as a function of the position of the carrier 43 in the build-up chamber 42. Furthermore, it is also possible for the signal for actuation of the barrier devices 176 to be coupled to the control signal for operation of the fan 109. It is preferable for all the barrier devices 176 to be closed in their at-rest position and for only the required barrier devices 176 to be opened during the suction and/or cooling in a process chamber 21, 24.

Furthermore, a suction line 117, which has a nozzle 116 for manual cleaning of the process chamber 21, 24 and the further surroundings of the process chamber 21, 24, opens out into the separation device 107.

A sensor element, which automatically switches on the fan 109 when the nozzle 116 is removed from the holder for the purpose of manual extraction by suction and opens the associated barrier device 176, so that the nozzle 116 is ready for operation, is provided at the nozzle 116 or at a frame for receiving the nozzle 116. The further barrier devices 176 remain closed.

The at least two process chambers 21, 24 furthermore preferably each have a separate cooling system 103 (FIG. 1), which cools components in and at the housing 31.

The air/gas which has been discharged from the build-up chamber 42 and the discharged build-up material 57 are therefore each fed to a separation device 107, assigned to each process chamber 21, 24, and a filter 108 connected downstream thereof. The separation device 107 comprises a collection vessel, in which the discharged build-up material 57 is collected. This collected build-up material 57 can be purified by a sieve arranged between the separation device 108 and the collection vessel or can be fed to an external preparation installation, in order subsequently to be used, via the feed device 72, for further layered build-up of a shaped body 52. The separate suction which is provided for each process chamber 21, 24 makes it possible to use different build-up materials while preventing mixing or contamination of the build-up material 52. In particular the barrier devices 176 prevent the respective circuits formed for each process chamber 21, 24 from influencing one another or becoming mixed with one another.

Furthermore, the apparatus according to the invention advantageously has an extinguishing installation which is provided for each process chamber 21, 24 and is at least partially integrated in the respective suction system. In the suction system there is a thermal monitoring element which monitors the temperature in the suction system. As soon as a limit value, which can be set and adapted to the build-up material 57, is exceeded, this monitoring element emits an emergency stop signal to the control and arithmetic unit 26. The fan 109 is then shut down. At the same time, the lines 106, 114, 117, 118, like the filter 108 and the separation device 107, are filled with shielding or inert gas and the barrier devices 176 are closed. The result of this measure is that the oxygen required for possible combustion is displaced by the shielding gas. This extinguishing installation has the advantage that following a cleaning process all the component parts can be used for the further production of shaped bodies 52.

At least two process chambers 21, 24 are operated jointly by one fan 109. This fan 109 is preferably designed as a radial fan and is connected, via connecting lines 118, to the respective separation devices 107 and filters 108 of the process chambers 21, 24. This advantageous arrangement and configuration of the process chambers 21, 24, and their assignment of component parts and the incorporation of barrier devices 176, enables each process chamber 21, 24 to be autonomous and to be hermetically locked. A common beam source 16 and a common beam-deflection device 18 are also provided. The further components are provided in a number corresponding to the number of process chambers 21, 24, making it possible to produce closed material circuits both for the build-up material 57 and for the shielding or inert gas.

While a shaped body 52 is being built up and produced in a process chamber 21, it is possible to carry out changeover work or to suck out build-up material 57 that has not been consolidated and/or to cool the shaped body 52 in the at least one further process chamber 24, without the adjacent process chamber(s) being affected. This allows optimum utilization of the beam source 16. In addition, different shaped bodies 52 with different build-up materials 57 and production parameters can be built up in each process chamber 21, 24.

The abovementioned principle is not restricted to double-chamber systems. Rather, it is also possible for three or more process chambers 21, 24 to be associated with one another. A beam-deflection device 18 may in each case be positioned with respect to the process chamber 21, 24, in order to guide a diverted beam onto the desired location within the working plane. Alternatively, it is also possible for the beam source 16 and beam-deflection device 18 to be of stationary design and for the process chambers 21, 24 to be moved relative to the beam-deflection device 18. By way of example, a turret arrangement is conceivable. In this configuration, it is also possible for both the beam-deflection device 18 and/or the radiation source 16 and the process chambers 21, 24 to be arranged displaceably relative to one another.

1. Apparatus for producing a three-dimensional shaped body by successive consolidation of layers of a pulverulent build-up material, which is consolidated by means of electromagnetic radiation or particle radiation, at locations corresponding to the respective cross section of the shaped body, having a beam source for generating a beam and a beam-deflection device for deflecting the beam onto the layer which is to be consolidated, having a carrier in a build-up chamber, arranged in a process chamber, for receiving the shaped body which is to be formed, characterized
in that at least two process chambers are provided,
in that each process chamber is hermetically locked off and is in each case designed to be separate from the adjacent process chamber, and
in that the beam-deflection device and the at least two process chambers are positioned in a processing position with respect to one another.

2. Apparatus according to claim 1, characterized in that each process chamber has an extraction means for build-up material that has not been consolidated, which extraction means comprises at least one barrier device.

3. Apparatus according to claim 1, characterized in that a fan is provided for the at least two process chambers, and at least one barrier device is provided in the extraction means between the fan and each process chamber.

4. Apparatus according to claim 1, characterized in that the process chamber has at least one inlet opening, which is closable by a barrier device.

5. Apparatus according to claim 2, characterized in that the barrier device is provided in at least one outlet opening, which is in communication with a build-up chamber, with a powder trap.

6. Apparatus according to claim 2, characterized in that the barrier device is provided with a nozzle for manual extraction.

7. Apparatus according to claim 2, characterized in that each barrier apparatus is actuated separately or jointly as a group for each process chamber by means of a control and arithmetic unit.

8. Apparatus according to claim 2, characterized in that the barrier device is designed as a pinch valve and actuated pneumatically, electrically, electromagnetically or hydraulically.

9. Apparatus according to claim 1, characterized in that the process chamber is hermetically sealed and is accessible through a closable opening which faces towards the beam-deflection device and has a region which transmits the electromagnetic radiation.

10. Apparatus according to claim 1, characterized in that a feed device, at least after the feeding of pulverulent build-up material, is arranged at least in a position which closes off the process chamber.

11. Apparatus according to claim 1, characterized in that the process chamber has at least one inlet nozzle leading into the process chamber and at least one extraction nozzle which leads away from the process chamber.

12. Apparatus according to claim 11, characterized in that the extraction nozzle is provided for leading away shielding or inert gas from the process chamber.

13. Apparatus according to one claim 1, characterized in that at least one seal is provided between the carrier and a peripheral wall, surrounding the carrier, of the build-up chamber.

14. Apparatus according to claim 13, characterized in that the seal is formed from a graphite material.

15. Apparatus according to claim 13, characterized in that the peripheral wall, facing towards the carrier, of the build-up chamber and at least the seal arranged in the carrier or a peripheral surface, facing towards the build-up chamber, of the carrier includes a material pairing which produces wear at the seal or the peripheral surface of the carrier.

16. Apparatus according to claim 11, characterized in that the surface hardness of the peripheral wall of the build-up chamber is designed to be greater than that of the build-up material.

17. Apparatus according to claim 11, characterized in that the building platform, adjacent to an end face or close to the end face, has a stripper element, which bears against the peripheral wall of the build-up chamber, as seal.

18. Apparatus according to claim 17, characterized in that the stripper element is designed as a felt ring.

19. Apparatus according to claim 2, characterized in that the extraction means, assigned to the process chamber, for build-up material that has not been consolidated comprises at least a separation device and a filter.

20. Apparatus according to claim 1, characterized in that there is a fan for the at least two process chambers, which fan is in each case connected downstream of a separation device and filter belonging to the process chamber.

21. Apparatus according to claim 1, characterized in that each process chamber comprises a separate store and feed device for the build-up material.

22. Apparatus according to claim 1, characterized in that the beam-deflection device is arranged displaceably between the at least two process chambers.

23. Apparatus according to claim 1, characterized in that the at least two process chambers are displaced with respect to the beam-deflection device.

24. Process for producing a three-dimensional shaped body, in particular using an apparatus according to one or more of the preceding claims, characterized in that in a first process chamber a layered build-up is carried out by successive consolidations of layers of a pulverulent build-up material, which is consolidated by means of electromagnetic radiation or particle radiation, to produce a shaped body, and at least a cooling, an extraction of build-up material that has not been consolidated, a removal of the finished component, a conversion or setting-up for the production of a new shaped body is carried out in at least a second process chamber.

25. Process according to claim 24, characterized in that, after production of a shaped body has been completed in a process chamber, the beam-deflection device is displaced to the at least one further process chamber, which has previously been converted or set up for the production of a shaped body by layered build-up.

26. Process according to claim 24, characterized in that shielding or inert gas flows through each process chamber at least during the successive consolidation of layers for the production of a shaped body.

27. Process according to claim 24, characterized in that barrier devices of the at least one further process chamber are held in a closed position at least during the extraction of build-up material that has not been consolidated or the cooling of a produced shaped body in a process chamber.
